(19) United States
(12) Patent Application Publication
(10) Pub. No.: US 2024/0333095 A1
(43) Pub. Date: Oct. 3, 2024

(54) ELECTRIC MOTOR AND FAN FOR A POWER TOOL

(71) Applicant: MILWAUKEE ELECTRIC TOOL CORPORATION, Brookfield, WI (US)

(72) Inventors: Kentez L. Craig, Milwaukee, WI (US); Amith J. Baskaran, Menomonee Falls, WI (US)

(21) Appl. No.: 18/614,262

(22) Filed: Mar. 22, 2024

Related U.S. Application Data
(60) Provisional application No. 63/455,010, filed on Mar. 28, 2023.

(51) Int. Cl. H02K 7/14; B25B 21/02; H02K 9/06

(52) U.S. Cl. CPC H02K 7/145; B25B 21/02; H02K 9/06

(57) ABSTRACT

A brushless DC electric motor including a stator and a rotor disposed within the stator. The stator includes a plurality of windings configured to generate magnetic fields, and the rotor includes a plurality of permanent magnets configured to interact with the magnetic fields generated by the plurality of windings. A fan is coupled for co-rotation with the rotor and includes a plurality of blades. The stator includes a first end defining a first end plane and a second end opposite the first end. The second end defines a second end plane such that the plurality of winding is disposed between the first end plane and the second end plane. The plurality of blades of the fan is positioned at least partially between the first and plane and the second end plane.

### CROSS-REFERENCE TO RELATED APPLICATIONS

This application claims priority to U.S. Provisional Patent Application No. 63/455,010, filed Mar. 28, 2013, the entire contents of which are incorporated by reference herein.

### FIELD

The present disclosure relates to electric motors, and more particularly to internal rotor electric motors for use with a power tool.

### BACKGROUND

A brushless DC electric motor includes at least a stator and a rotor. A plurality of permanent magnets are supported by the rotor, which receives torque as a result of the interaction between the permanent magnets and magnetic fields created by the stator, thus causing the rotor to rotate. In some instances, the brushless DC electric motor will include a fan coupled for co-rotation with the rotor.

### SUMMARY

The present disclosure provides, in one aspect, a brushless DC electric motor including a stator and a rotor disposed within the stator. The stator includes a plurality of windings configured to generate magnetic fields, and the rotor includes a plurality of permanent magnets configured to interact with the magnetic fields generated by the plurality of windings. A fan is coupled for co-rotation with the rotor and includes a plurality of blades. The stator includes a first end defining a first end plane and a second end opposite the first end. The second end defines a second end plane such that the plurality of winding is disposed between the first end plane and the second end plane. The plurality of blades of the fan is positioned at least partially between the first and plane and the second end plane.

The present disclosure provides, in another aspect, a power tool including a brushless DC electric motor, a housing in which the brushless DC electric motor is disposed, a camshaft driven by the brushless DC electric motor, an anvil extending from the housing, and a hammer configured to reciprocate along the camshaft to deliver striking rotational impacts to the anvil in response to rotation of the camshaft. The brushless DC electric motor includes a stator defining an outer periphery of the brushless DC electric motor, a rotor disposed within the stator, an output shaft coupled to the rotor and extending along a rotational axis of the brushless DC electric motor, and a fan coupled for co-rotation with the output shaft. A portion of the fan is disposed within the outer periphery of the brushless DC electric motor.

The present disclosure provides, in yet another aspect, a power tool including a brushless DC electric motor, a housing supporting the brushless DC electric motor, a battery selectively coupled to the housing and configured to provide power to the brushless DC electric motor, and an output configured to be driven by the brushless DC electric motor. The brushless DC electric motor includes a stator defining an outer periphery of the brushless DC electric motor, a rotor disposed within the stator, an output shaft coupled to the rotor and extending along a rotational axis of the brushless DC electric motor, and a fan coupled for co-rotation with the output shaft. The housing includes an end cap, and the fan is rotatably supported by the end cap.

Other features and aspects of the disclosure will become apparent by consideration of the following detailed description and accompanying drawings.

### BRIEF DESCRIPTION OF THE DRAWINGS

FIG. 1 is a perspective view of a power tool according to an embodiment of the present disclosure.

FIG. 2 is a partial cross-sectional view of the power tool of FIG. 1, taken along section line 2-2 in FIG. 1.

FIG. 3 is an upper rear perspective view of a brushless DC electric motor according to an embodiment of the present disclosure.

FIG. 4 is a side view of the brushless DC electric motor of FIG. 3.

FIG. 5 is a cross-sectional view of a portion of a power tool including the brushless DC electric motor of FIG. 3.

FIG. 6 is a perspective view of a fan for use with the brushless DC electric motor of FIG. 3.

FIG. 7 is cross-sectional view of a portion of a power tool including a brushless DC electric motor and fan according to another embodiment of the disclosure.

FIG. 8 is a perspective view of the fan of FIG. 7.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

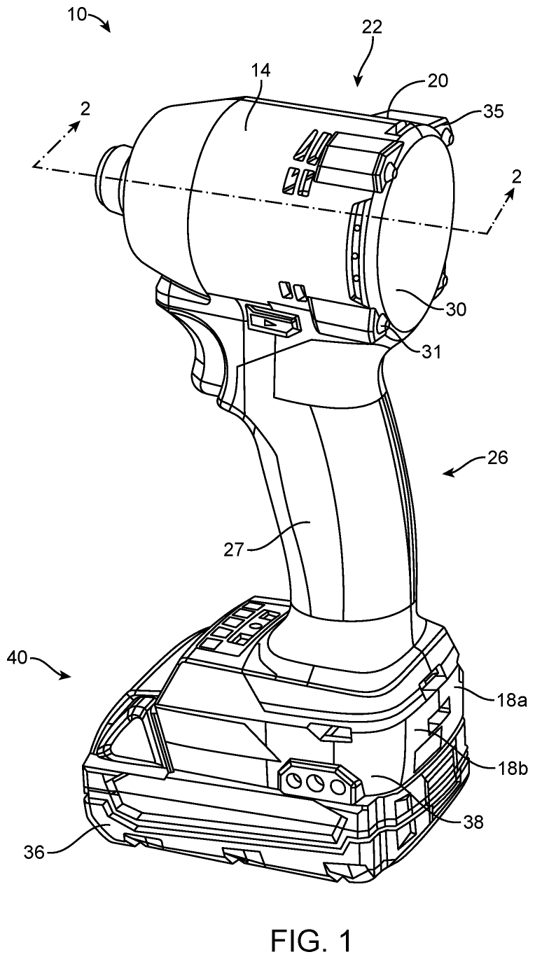

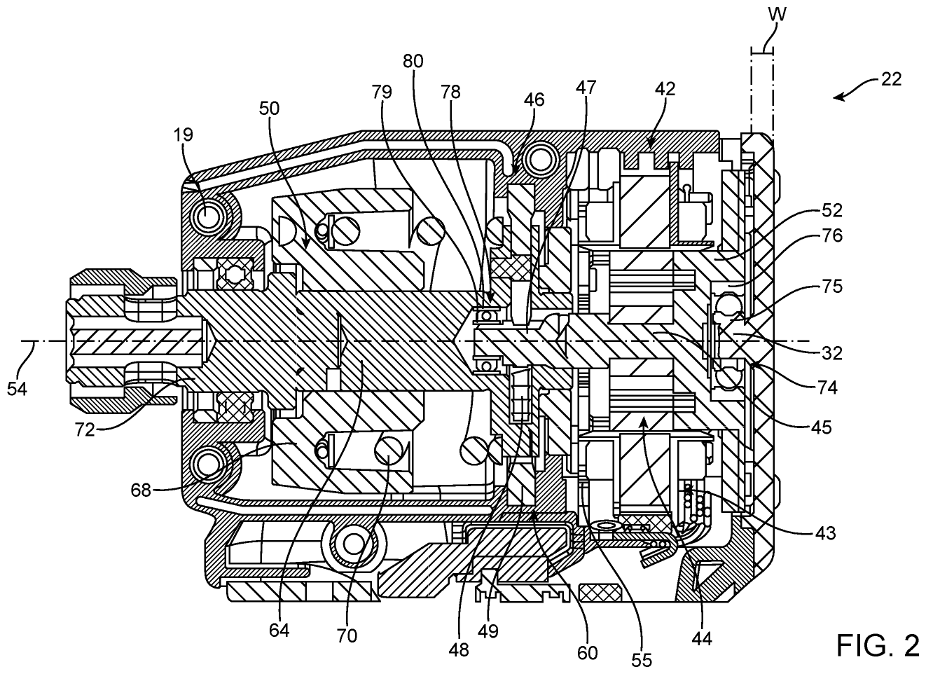

FIGS. 1 and 2 illustrate an embodiment of a power tool 10 in the form of a rotary impact tool, and, more specifically, an impact driver. The power tool 10 includes a housing 14 defined by cooperating first and second clamshell halves or housing portions 18a, 18b coupled together (e.g., by a first plurality of fasteners 19; FIG. 2) at a parting plane or seam 20. In the illustrated embodiment, the seam 20 is positioned along a longitudinal center plane of the power tool 10.

The housing 14 includes a head housing portion 22 and a handle portion 26 extending downwardly from the head housing portion 22. In the illustrated embodiment, the handle portion 26 is covered or surrounded by a grip portion 27. The illustrated housing 14 further includes an end cap 30 coupled to a rear portion of the head housing portion 22 (e.g., by a second plurality of fasteners 31). In the illustrated embodiment, the end cap 30 spans across both of the clamshell halves 18a, 18b.

The power tool 10 further includes a battery 36 removably coupled to a battery receptacle 38 located at a bottom end or foot 40 of the handle portion 26. A motor 42 (e.g., a brushless DC electric motor, FIG. 2), a gear assembly 46, and an impact mechanism 50 are enclosed within the head housing portion 22 (FIG. 2). The motor 42 includes a stator 43 that is directly supported by the clamshell halves 18a, 18b. The stator 43 may include, for example, a stator frame and a plurality of coils or windings. The motor 42 further includes a rotor 44 comprising a plurality of laminations and embedded permanent magnets, an output shaft 45, and a fan 52. The output shaft 45 and the fan 52 are coupled for co-rotation with the rotor 44 about an axis 54 relative to the stator 43. A sensor PCB 55, which includes a plurality of sensors (e.g., Hall-effect sensors) for detecting rotation of the rotor 44, is coupled to a front side of the frame of the stator 43. In other embodiments, the sensor PCB 55 may be coupled to a rear side of the frame of the stator 43. In yet other embodiments, the motor 42 may be configured for sensorless control, such that the sensor PCB 55 may be omitted.

With continued reference to FIG. 2, the end cap 30 includes a post 32 extending from a body of the end cap 30 toward the front side of the power tool 10 along the axis 54. In the illustrated embodiment, the post 32 is integrally formed with the end cap 30. The post 32 is received within a rear rotor bearing 74 (e.g., ball bearing) and contacts an inner race 75 of the rear rotor bearing 74. The inner race 75 is fixedly coupled to the post 32, such that the inner race 75 may not rotate. In some embodiments, the inner race 75 may include lugs that are received by recesses in the post 32 to further secure the inner race 75 to the post 32. In other embodiments, the post 32 may include lugs and the inner race 75 may include recesses to receive the lugs.

The rear rotor bearing 74 further includes an outer race 76 received within and coupled to the fan 52. The rear rotor bearing 74 is configured to support the fan 52, and the outer race 76 rotates with the fan 52 during operation. The fan 52 supports the output shaft 45, which in turn supports the rotor 44. Thus, the rear rotor bearing 74 supports a rear end portion of a rotor assembly, the rotor assembly comprising the rotor 44, output shaft 45, and fan 52. In some embodiments, the outer race 76 may include lugs that are received by recesses in the fan 52 to further secure the outer race 76 to the fan 52. In other embodiments, the fan 52 may include lugs and the outer race 76 may include recesses to receive the lugs.

In the illustrated embodiment, a rear surface of the rear rotor bearing 74 is flush with a rear surface of the fan 52, such that the entire rear rotor bearing 74 is disposed within the fan 52. This provides for a more compact length along the axis 54. In other embodiments, however, the rear rotor bearing 74 may be only partially recessed within the fan 52.

The gear assembly 46 and impact mechanism 50 will now be described with reference to FIG. 2. In the illustrated embodiment, the gear assembly 46 includes a pinion 47 coupled to the output shaft 45, a plurality of planet gears 48 meshed with the pinion 47, and a ring gear 49 meshed with the planet gears 48. In some embodiments, the pinion 47, planet gears 48, and the ring gear 49 may be spur gears, helical gears, or other suitable types of gears. The ring gear 49 is rotationally fixed within a recess 60 in the head housing portion 22 and is directly supported by the clamshell halves 18a, 18b. In some embodiments, the ring gear 49 may include lugs that are received in additional recesses or grooves within the head housing portion 22 to further fix the ring gear 49 within the head housing portion 22.

The planet gears 48 are coupled to a camshaft 64 of the impact mechanism 50 such that the camshaft 64 acts as a planet carrier. Accordingly, rotation of the output shaft 45 rotates the planet gears 48, which then advance along the inner circumference of the ring gear 49 and thereby rotate the camshaft 64. The impact mechanism 50 further includes a hammer 68 supported on and axially slidable relative to the camshaft 64, a spring 70 partially disposed within the hammer and configured to bias the hammer along the axis 54 toward a front side of the power tool 10, and an anvil 72. The hammer 68 is configured to reciprocate axially along the camshaft 64 to impart rotational impacts to the anvil 72 in response to rotation of the camshaft 64.

The pinion 47 is rotatably supported by a front rotor bearing 78 (e.g., ball bearing). The front rotor bearing 78 is disposed within a cavity in the camshaft 64 and includes an inner race 79 and an outer race 80. The inner race 79 is coupled to the pinion 47 and rotates with the pinion 47, and the outer race 80 is coupled to the camshaft 64 and rotates with the camshaft 64. Similar to the rear rotor bearing 74, the front rotor bearing 78 may include lugs or apertures on the inner race 79 and/or the outer race 80 that engage with lugs or apertures on the respective surfaces contacted by the inner race 79 and the outer race 80.

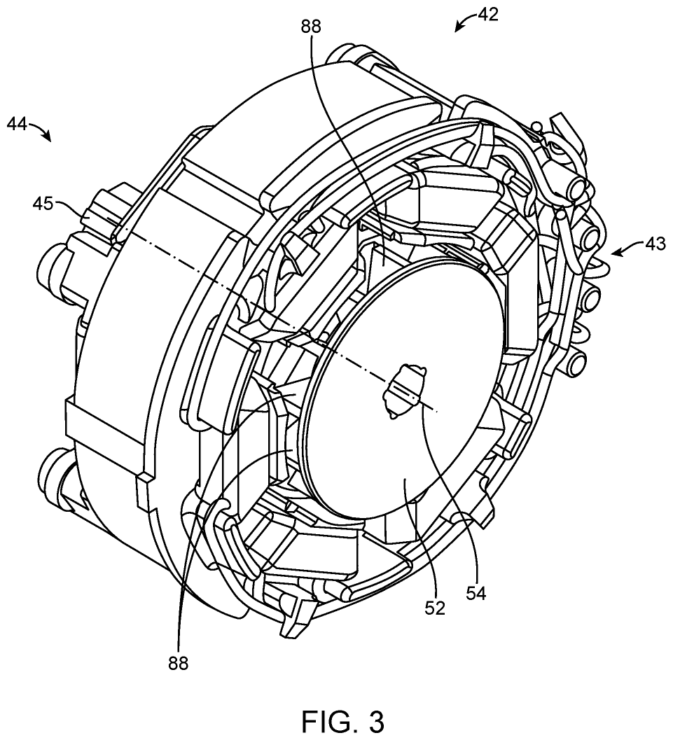

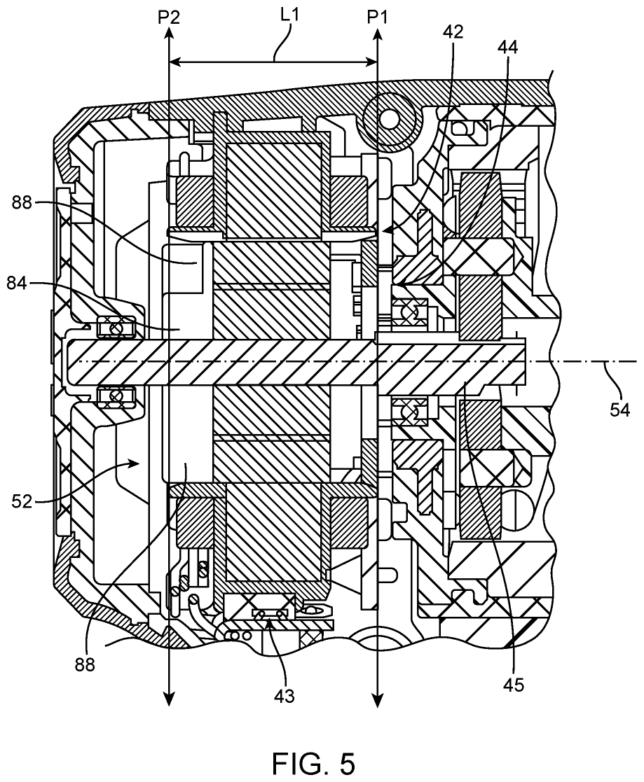

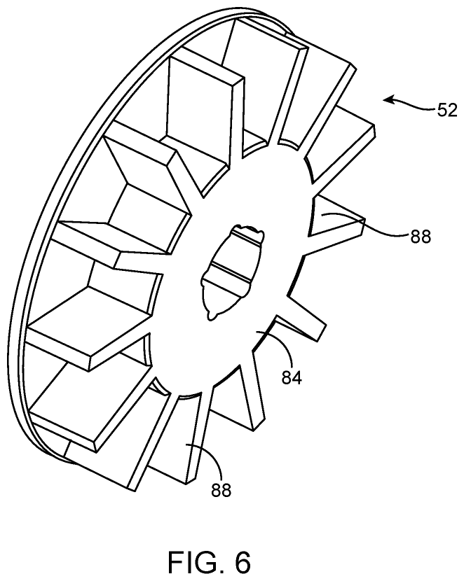

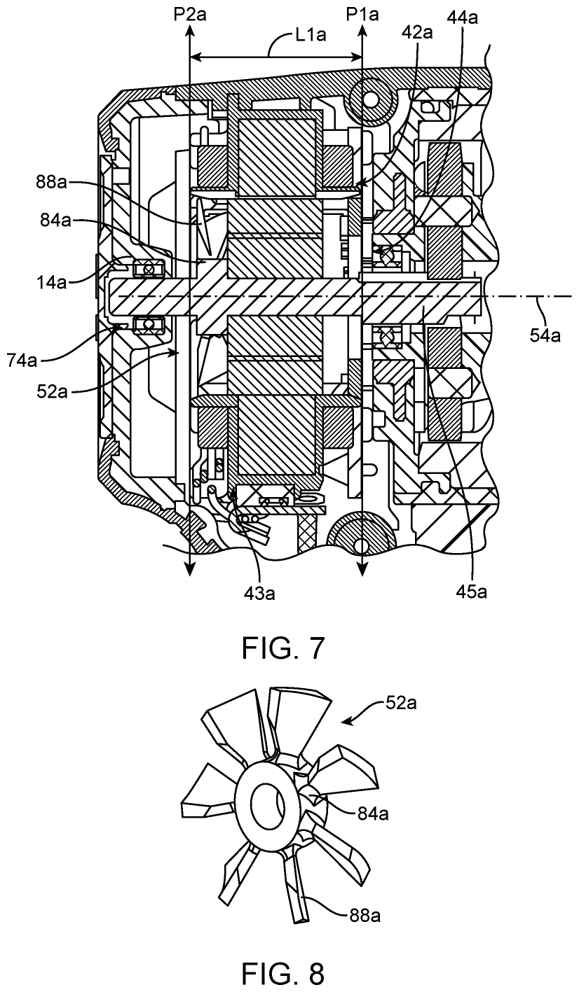

With reference to FIGS. 3-6, the fan 52 is coupled for co-rotation with the output shaft 45 of the rotor 44. The fan 52 is a centrifugal fan including a hub 84 to be coupled to the output shaft 45 for co-rotation therewith and a plurality of fan blades 88. The plurality fan blades 88 are oriented to induce an airflow radially away from the axis 54 of the fan 52 when the fan 52 is rotated. Therefore, the fan 52 induces an airflow through the motor 42 (e.g., through the stator 43 and around the rotor 44). With reference to FIGS. 7 and 8, in some embodiments the fan 52a is an axial flow fan configured to generate an airflow along the axis 54a. In still other embodiments, a fan may generate an airflow both along the axis 54 and radially relative to the axis 54.

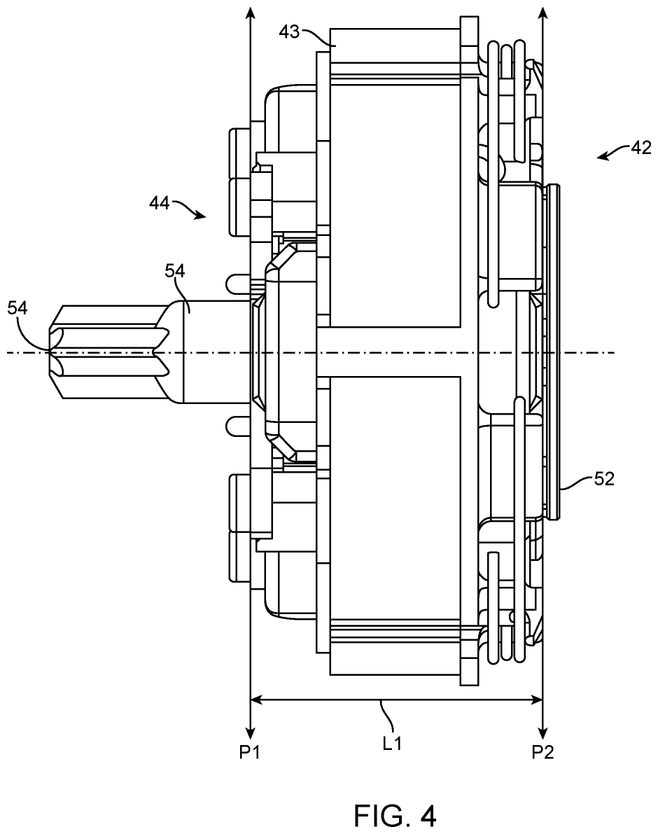

With continued reference to FIGS. 3-6, the stator 43 generally defines an outer periphery of the motor 42, and the fan 52 is disposed at least partially within the outer periphery of the motor 42. The outer periphery of the motor 42 defines a length L1 of the motor 42. Referring to FIG. 4, the length L1 of the motor 42 can be measured between opposed axial end planes P1 and P2 of the stator 43. The length L1 is sufficient to contain at least the rotor 44 therein. In the illustrated embodiment, the fan 52 is coupled to the rotor 44 in such a way so as to be positioned at least partially within the outer periphery of the motor 42. Therefore, at least a portion of the fan 52 extends to a position within between the opposed axial end planes P1 and P2 of the stator 43. More particularly, the fan blades 88 have a length measured parallel to the axis 54, and at least a portion of each fan blade's length is positioned within the outer periphery of the motor 42. In some embodiments, at least half of the length of the fan blades are within the outer periphery. In the illustrated embodiment, a majority of the length of the fan blades is positioned within the outer periphery.

The fan 52 has been described in connection with a power tool 10 in which the rear rotor bearing 74 is disposed within the fan 52 to support the fan 52. It should be understood that in other embodiments the fan 52 and rotor 44 may be supported for rotation by other bearing orientations. For example, with reference to FIG. 7, the fan 52a is supported by the output shaft 45a, and the output shaft 45a extends rearward beyond the fan 52a. The rear rotor bearing 74a is coupled between the output shaft 45a and the housing 14a, and the rear rotor bearing 74a is not positioned within the fan 52.

Although the disclosure has been described in detail with reference to certain preferred embodiments, variations and modifications exist within the scope and spirit of one or more independent aspects of the disclosure as described. For example, power tool 10 is described and illustrated herein as an impact tool; however, in other embodiments, the brushless DC electric motor and fan may be incorporated into other types of power tools, including continuous torque tools such as drills, powered screwdrivers, and the like.

Various features and aspects of the present disclosure are set forth in the following claims.

What is claimed is:

1. A brushless DC electric motor comprising:
a stator including a plurality of windings configured to generate magnetic fields;
a rotor including a plurality of permanent magnets configured to interact with the magnetic fields generated by the plurality of windings; and
a fan coupled for co-rotation with the rotor, the fan including a plurality of blades,
wherein the stator includes a first end defining a first end plane and a second end opposite the first end, the second end defining a second end plane such that the plurality of windings are disposed between the first end plane and the second end plane, and
wherein the plurality of blades of the fan is positioned at least partially between the first end plane and the second end plane.

2. The brushless DC electric motor of claim 1, wherein the fan is configured to generate an airflow along a rotational axis of the rotor.

3. The brushless DC electric motor of claim 1, wherein the fan is configured to generate an airflow radially away from a rotational axis of the motor.

4. The brushless DC electric motor of claim 1, wherein the rotor includes an output shaft, and wherein the fan is coupled for co-rotation with the output shaft.

5. The brushless DC electric motor of claim 1, wherein the plurality of blades has a length measured parallel to a rotational axis of the motor, and wherein half of the length of the plurality of blades is disposed between the first end plane and the second end plane.

6. The brushless DC electric motor of claim 5, wherein a majority of the length of the plurality of blades is disposed between the first end plane and the second end plane.

7. A power tool comprising:
a brushless DC electric motor including
a stator defining an outer periphery of the brushless DC electric motor,
a rotor disposed within the stator,
an output shaft coupled to the rotor, the output shaft extending along a rotational axis of the brushless DC electric motor, and
a fan coupled for co-rotation with the output shaft,
a housing in which the brushless DC electric motor is disposed;
a camshaft driven by the brushless DC electric motor;
an anvil extending from the housing; and
a hammer configured to reciprocate along the camshaft to deliver striking rotational impacts to the anvil in response to rotation of the camshaft,
wherein a portion of the fan is disposed within the outer periphery of the brushless DC electric motor.

8. The power tool of claim 7, wherein the fan is configured to generate an airflow along the rotational axis of the brushless DC electric motor.

9. The power tool of claim 8, wherein the fan is configured to generate an airflow radially away from the rotational axis of the brushless DC electric motor.

10. The power tool of claim 7, wherein the fan includes a plurality of blades, and wherein at least half of a length of the plurality of blades is disposed within the outer periphery of the brushless DC electric motor.

11. The power tool of claim 7, wherein the housing includes an end cap and a post extending from the end cap, wherein a bearing is disposed on the post and configured to rotatably support the rotor.

12. The power tool of claim 11, wherein the bearing rotatably supports the fan.

13. The power tool of claim 12, wherein the bearing includes a front end and a rear end opposite the front end, the rear end being disposed adjacent to the end cap, and wherein the rear end is flush with a rear surface of the fan.

14. A power tool comprising:
a brushless DC electric motor including
a stator defining an outer periphery of the brushless DC electric motor,
a rotor disposed within the stator,
an output shaft coupled to the rotor, the output shaft extending along a rotational axis of the brushless DC electric motor, and
a fan coupled for co-rotation with the output shaft,
a housing supporting the brushless DC electric motor;
a battery selectively coupled to the housing, the battery configured to provide power to the brushless DC electric motor; and
an output configured to be driven by the brushless DC electric motor,
wherein the housing includes an end cap, and
wherein the fan is rotatably supported by the end cap.

15. The power tool of claim 14, further comprising a bearing disposed between the end cap and the fan.

16. The power tool of claim 15, wherein the bearing is recessed within the fan such that a rear end of the bearing is flush with a rear surface of the fan.

17. The power tool of claim 14, wherein at least a portion of the fan is disposed within the outer periphery of the brushless DC electric motor.

18. The power tool of claim 17, wherein the fan is an axial flow fan.

19. The power tool of claim 18, wherein the fan is further configured to generate an airflow radially away from a rotational axis of the brushless DC electric motor.

20. The power tool of claim 17. wherein at least half of a length of the fan is disposed within the outer periphery of the brushless DC electric motor.
